(19) United States
(12) Patent Application Publication
(10) Pub. No.: US 2020/0326059 A1
(43) Pub. Date: Oct. 15, 2020

(54) More light flashlight

(71) Applicant: Craig Larrimore, Los Angeles, CA (US)

(72) Inventor: Craig Larrimore, Los Angeles, CA (US)

(21) Appl. No.: 16/383,319

(22) Filed: Apr. 12, 2019

(51) Int. Cl. F21V 21/14; F21L 4/00

(52) U.S. Cl. CPC F21V 21/145; F21L 4/005

(57) ABSTRACT

A flashlight with multiple uses, and parts used to execute the different functions. These parts include an extended lens, the head, collar leg assembly, and cap are either fixed or mounted to the flashlight to facilitate the different functions such as the work light, torch light, lamp, signaling light or lamp, safety beacon or emergency lamp, and a hook is mounted to the cap to provide hanging or overhead lighting.

### FIELD OF THE INVENTION

The present invention relates primarily to flashlights, and in particular to a flashlight that can be conveniently held in hand, or just as convenient on its own. By self-standing, or suspended over head to facilitate uses at camp sites, exploring, emergency situations and the like.

### BACKGROUND OF THE INVENTION

The present invention relates primarily to flashlights. It intends to provide a plurality of functions which are able to be used in different situations. By changing into different configurations. Various flashlight designs have addressed improvements to the form of lighting characteristics of the flashlight that varies in its applications and basic function.

However, the disadvantages of certain flashlights are that these designs are limited with minimal additions added to the design. This limits the ability to applying light only for the configuration for which it was applied. It is therefore desirable to provide a flashlight to be hand-held with a multiple function of free standing or suspended for most any lighting need or situation.

### SUMMARY OF THE INVENTION

It is an object of the present invention to provide a flashlight having multiple characteristics to facilitate several uses.

It is another object of the present invention to provide a flashlight having a movable head connecting to reflector to provide applicable uses when hand-held, free standing, or suspended overhead.

It is another object of the present invention to provide a clear lens cap to facilitate side visibility for area lighting and side projecting lens for beacon.

It is another object of present invention to provide a collar with grips mounted on the body to raise and lower the legs.

It is another object of the present invention to provide a plurality of legs mounted to collar and lower the end of the flashlight body. The collapsible legs are two parts connected together at the hinge with built-in landing pads to facilitate secured free standing.

t is another object of the present invention to provide having a hook built into the end cap to allow for suspended overhead lighting. Such as a hanging lamp, work light, or spot light.

It is yet another object of the present invention to provide a flashlight having a soft-touch button to engage either a direct beam or flashing (strobe) light, for a beacon, spot, or warning light.

Further objects, advantages, and features of the present invention will become apparent from the following detailed descriptions with an appropriate reference to the accompanying drawings.

### BRIEF DESCRIPTION OF DRAWINGS

FIG. 1 Is a side elevation view of flashlight.

FIG. 2 Is a side elevation view of the flashlight and its assembled parts.

FIG. 3 Is a side elevation of the flashlight with head retracted for use as a torch or hook extended for use as hanging lamp.

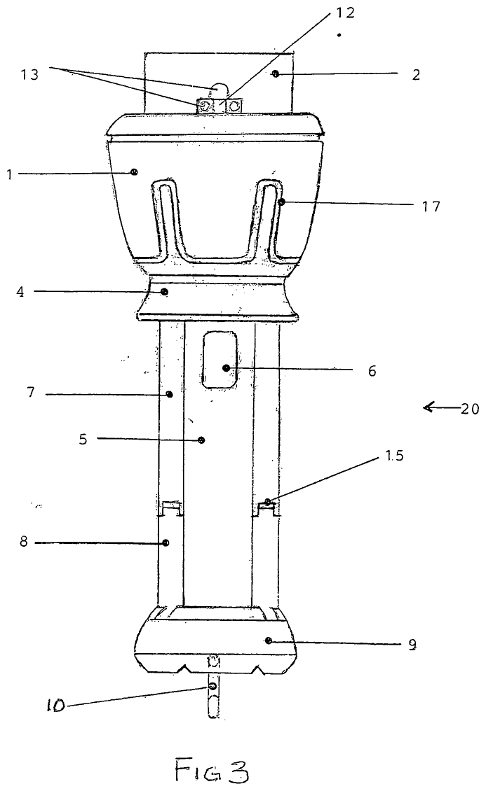

FIG. 4 Is a side elevation of the flashlight with legs extended for use as a work, spot, or warning light.

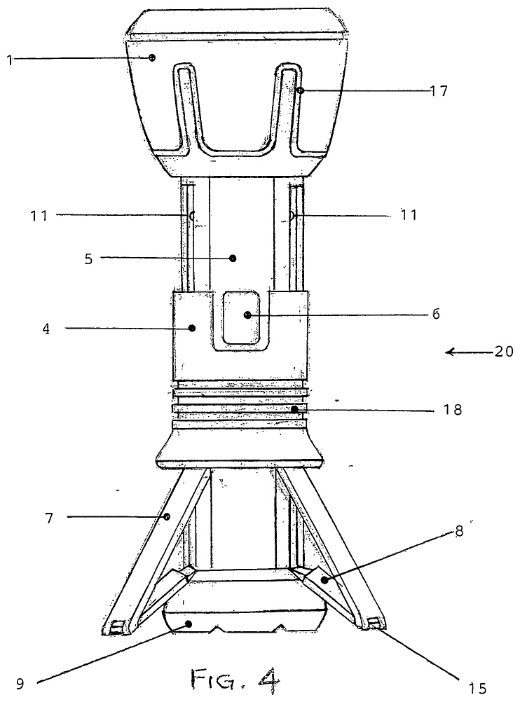

FIG. 5 Is a side elevation view of the flashlight with head retracted and legs extended as a lamp, warning light, or emergency beacon with its self-standing capability.

FIG. 6 Is a side elevation view of flashlight with its head retracted and legs extended for lamp and view of assembled parts.

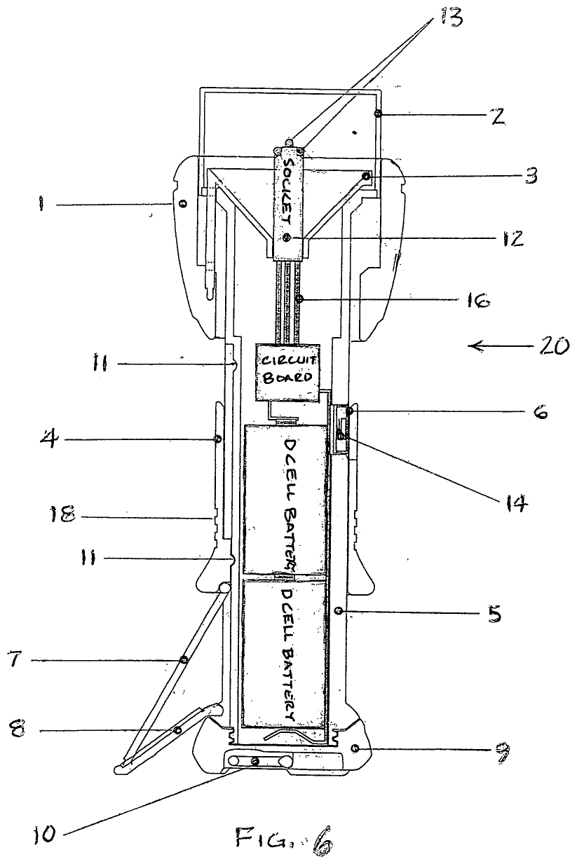

FIG. 7 Is a side elevation of the cap with view of the built-in hook for suspended or overhead lighting.

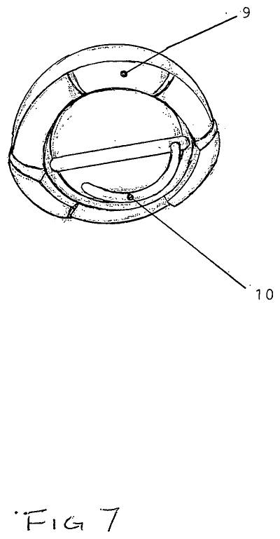

### DETAILED DESCRIPTION OF THE INVENTION

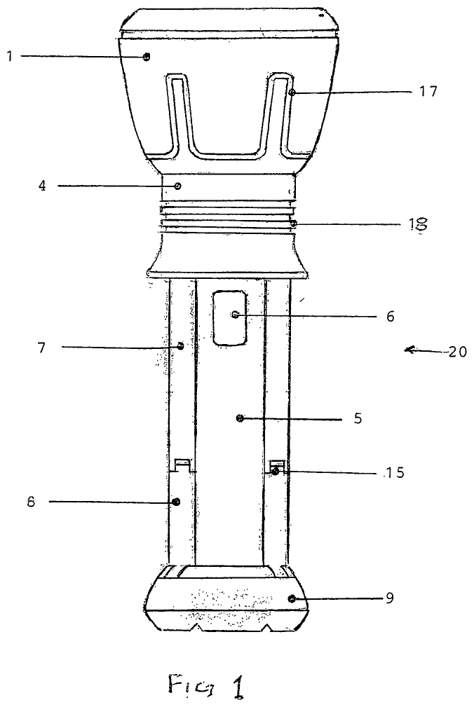

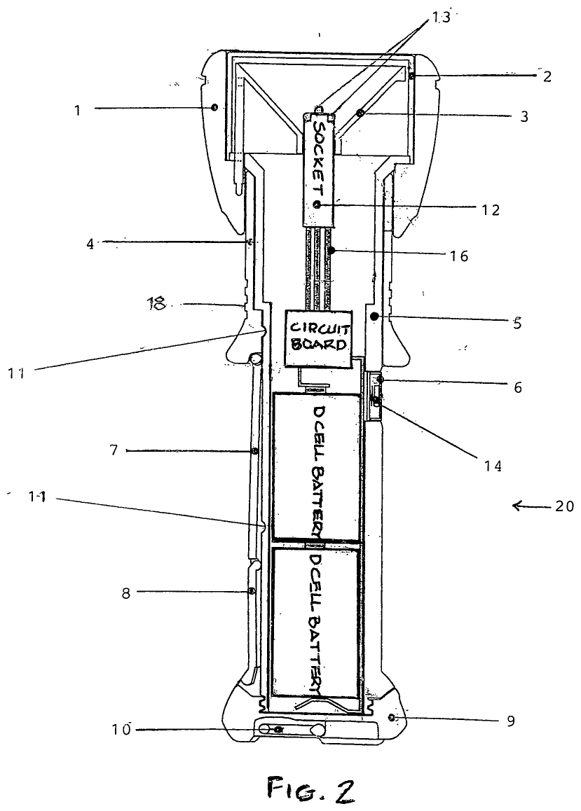

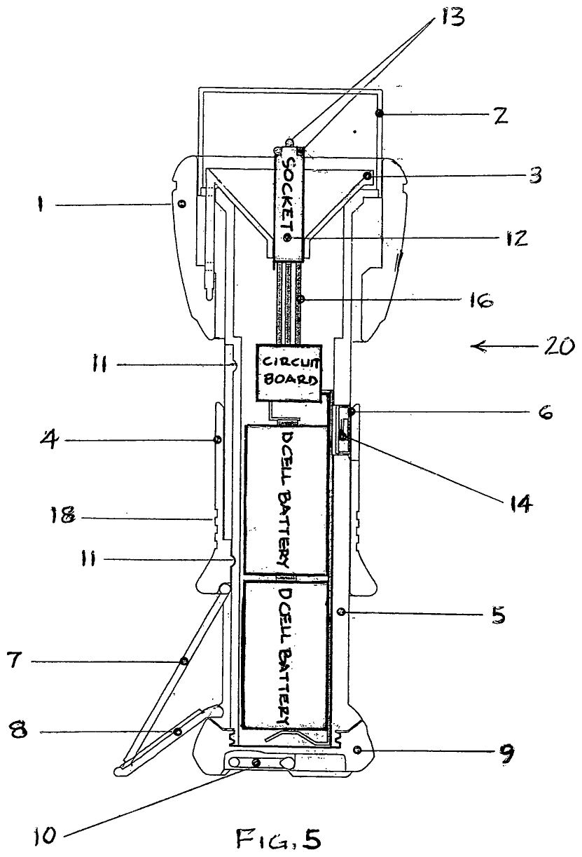

In the form of the present invention chose for purposes illustration, FIG. 1 shows side elevation of flashlights, having a generally cylindrical body (5) with a removable end cap (9) at lower end to facilitate insertion and removal of batteries shown. As seen FIG. 5 a hook (10) is mounted on the end cap (9) to allow the flashlight FIG. 1 to be hung from any convenient object. At forward end of body (5) as best seen in FIG. 1 is stock 12 with L E Ds 13, and reflector mirror (3) lens cap 2 encircling stock L E Ds of list Non-Modeled Parts. A protective head (1) is mountable to reflector mirror (3) covering lens cap 2 is slideably mounted on the body (5) and is movable between a Forward position encircling the lens cap 2 and L E Ds (13), as seen in FIG. 1 and, a lowered position, as see in FIG. 2, which permits light from L E Ds (13) to radiate laterally for use as lamp or beacon. A plurality of legs (7), (8), are mounted on the body (5) and are movable between a stored position, lying parallel to the body (5), as seen in FIG. 1, and an extended position, as seen FIG. 2. Finally, a switch (14) is provided on the body (5) and serves the flashlight FIG. 1 on and off. Also, a switch cover 6 serves to switch lamp and beacon FIG. 2 on and off. To move the reflector mirror (3) between its normal raised position in FIG. 1 and the retracted position shown in FIG. 2 is movable by head (1).

In use the flashlight may be used in the normal by grasping the body (5) and actuating the switch (14) to turn on the light FIG. 1. However, if the user wishes to use the flashlight as a beacon or lamp. They simply extend the legs (7), (8) to the position seen in FIG. 2. The legs (7), (8) will then support the flashlights in vertical position seen in FIG. 2 by sliding head (1) to downward position seen FIG. 2 the light from L E Ds radiates laterally. If desired head (1) could be in position of FIG. 2 while legs (7), (8) are stored in position FIG. 1. The move head (1) laterally to provide a hand-held lamp or torch, or extend hook (10) for hanging lamp or beacon.

Obviously, numerous variations and modifications can be made without departing from the spirit of the present invention. Therefore, it should be clearly understood the form of the present invention described above and shown in the figures of the accompanying pictures are not intended to limit scope of the present invention.

What is claimed is:

1. A flashlight comprising:
A cylindrical body capable of retaining two or more batteries (d, c, aa, or aaa), with a movable lens cover mounted at upper portion of the body and attached to the mirror reflector that surrounds socket tree comprising of fitted led bulbs having a positive contact and ground contact, comprising a soft-touch button mounted on body for a means of switching on and off the various circuits used to power the different circuits in different applications.
A collar pivotally mounted on cylindrical body, having grooves and detents fitted in outer periphery to engage and disengage collar, and collapsible legs fitted in grooves, the legs are connected to lower end of collar and the lower end of cylindrical body, the end cap is threadedly fitted at lower end of body, has a built-in hook to facilitate suspended uses.

2. The flashlight of claim 1, wherein the socket tree is mounted inside the top portion of cylindrical body, comprising side projecting lens, conveniently mounted to allow for longitudinal movement of mirror reflector for various uses such as the lamp or beacon.

3. The flashlight of claim 1, wherein comprising mirror reflector surrounding socket tree to allow for longitudinal movement up and down to facilitate direct light or area light functions as orchestrated by head movement.

4. The flashlight of claim 1, wherein comprising of lens cover lens cap as assembled with mirror reflector, has side grips for lowering and raising lens cover as needed for direct light or area light.

5. The flashlight of claim 1, further comprising a clear lens cap for side visibility when creating mass area light, and allows for longitudinal movement from within by mirror reflector as it is operated by lens cover.

6. The flashlight of claim 1, wherein comprising cylindrical body treaded at forefront, or top and bottom. Is fitted to mount socket tree, body is adorned with groves, detents, and button opening for the various apparatus used to facilitated different functions.

7. The flashlight of claim 1, wherein the collar with cut out access for soft touch button, an enlarged angled bottom for support and positioning of legs that are attached.

8. The flashlight of claim 1, wherein comprising a plurality of collapsible legs mounted on the end of collar and the bottom of cylindrical body, the legs are fitted with hinges with built-in landing pads.

9. The flashlight of claim 1, further comprising the end cap that is connected to end of cylindrical body and fitted with built-in hook for suspended light; a hanging lamp, work, or spot light.

10. The flashlight of claim 1, wherein the invention is to provide a flashlight having a soft touch button to operate direct beam of flashing light, for a beacon, spot, or warning light.
